(19) United States
(12) Patent Application Publication
(10) Pub. No.: US 2024/0364436 A1
(43) Pub. Date: Oct. 31, 2024

(54) SYSTEM AND METHOD FOR WIRELESS COMMUNICATIONS WITH INTERFERENCE

(71) Applicant: NXP USA, Inc., Austin, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US); Yi-Ling Chao, Sunnyvale, CA (US)

(21) Appl. No.: 18/646,558

(22) Filed: Apr. 25, 2024

Related U.S. Application Data
(60) Provisional application No. 63/498,165, filed on Apr. 25, 2023.
(60) Provisional application No. 63/510,614, filed on Jun. 27, 2023.
(60) Provisional application No. 63/519,045, filed on Aug. 11, 2023.
(60) Provisional application No. 63/578,373, filed on Aug. 24, 2023.

(51) Int. Cl. H04B 17/309; H04L 5/00; H04W 74/0816

(52) U.S. Cl. CPC H04B 17/345; H04L 5/0053

(57) ABSTRACT

Embodiments of a method and apparatus for wireless communications are disclosed. In an embodiment, a wireless device includes a controller configured to generate a frame that includes interference information indicating an existence or an occurrence of a wireless communications interference and a wireless transceiver configured to transmit the frame through an antenna.

### CROSS-REFERENCE TO RELATED APPLICATIONS

This application is entitled to the benefit of U.S. Provisional Patent Application Ser. No. 63/498,165, filed on Apr. 25, 2023, U.S. Provisional Patent Application Ser. No. 63/510,614, filed on Jun. 27, 2023, U.S. Provisional Patent Application Ser. No. 63/519,045, filed on Aug. 11, 2023, and U.S. Provisional Patent Application Ser. No. 63/578,373, filed on Aug. 24, 2023, the contents of each of which are incorporated by reference herein.

### BACKGROUND

Wireless communications devices, e.g., access points (APs) or non-AP devices can transmit various types of information using different transmission techniques. For example, various applications, such as, Internet of Things (IoT) applications can conduct wireless local area network (WLAN) communications, for example, based on Institute of Electrical and Electronics Engineers (IEEE) 802.11 family of standards (e.g., Wi-Fi standards). Some applications, for example, video teleconferencing, streaming entertainment, high definition (HD) video surveillance applications, outdoor video sharing applications, etc., require relatively high system throughput. Wireless communications interference can affect wireless communication throughput. For example, in-device coexisting radio(s), such as, a Bluetooth transmitter may interfere with a WLAN (e.g., Wi-Fi) transmitter because the WLAN (e.g., Wi-Fi) transmitter might know for periodic activity or might not know for aperiodic activity beforehand when the interference may occur.

### SUMMARY

Embodiments of a method and apparatus for wireless communications are disclosed. In an embodiment, a wireless device includes a controller configured to generate a frame that includes interference information indicating an existence or an occurrence of a wireless communications interference and a wireless transceiver configured to transmit the frame through an antenna. Other embodiments are also disclosed.

In an embodiment, the interference information indicates that an interference source is located within the wireless device.

In an embodiment, the wireless device further includes a second wireless transceiver, and the interference information indicates that the interference source includes the second wireless transceiver.

In an embodiment, the wireless transceiver is compatible with an Institute of Electrical and Electronics Engineers (IEEE) 802.11 protocol, and the second wireless transceiver is not compatible with the IEEE 802.11 protocol.

In an embodiment, the second wireless transceiver is compatible with a short range wireless communications protocol.

In an embodiment, the interference information includes interference activation indication information, periodic indication information, interference bandwidth bitmap information that is within a Basic Service Set (BSS) operating bandwidth (BW), and a restriction of transmitter/receiver (Tx/Rx) parameters.

In an embodiment, the interference information further includes periodic in-device radio service period (SP) information.

In an embodiment, the frame includes a beacon frame, a probe response, or an association request/response frame.

In an embodiment, the interference information indicates the existence of the wireless communications interference with a second wireless device, and the wireless transceiver is further configured to transmit the beacon frame, the probe response, or the association request/response frame to announce the interference information.

In an embodiment, the interference information indicates that erroneous or missing Media Access Control (MAC) protocol data units (MPDUs) in one or more physical layer protocol data units (PPDUs) caused by the wireless communications interference.

In an embodiment, the frame includes a block acknowledgment (BA) frame.

In an embodiment, the interference information indicates that unacknowledged MPDUs caused by the wireless communications interference.

In an embodiment, the frame includes a Quality of service (QOS) Null frame or an action frame.

In an embodiment, the interference information indicates a past period in which the wireless communications interference occurred.

In an embodiment, the interference information indicates the existence of the wireless communications interference with a second wireless device, second interference information transmitted by the second wireless device in a responding frame indicates an available time duration that is smaller than a remaining transmit opportunity (TXOP) duration, and the wireless device as a TXOP holder finishes a frame exchange with the second wireless device within the second wireless device's available time duration.

In an embodiment, the second interference information is carried in a duration field of the responding frame's MAC header.

In an embodiment, the wireless device includes a wireless access point (AP) or a non-AP wireless station (STA) device.

In an embodiment, the wireless device is a component of a multi-link device (MLD), and the interference information of the wireless device is reported to a peer wireless device of the MLD that is connected to the wireless device via a first link through a second link.

In an embodiment, a wireless device includes a controller configured to generate a beacon frame that includes interference information indicating an existence of a wireless communications interference with a second wireless device and a wireless transceiver configured to transmit the beacon frame to the second wireless device through an antenna.

In an embodiment, a method for wireless communications includes at a first wireless device, generating a frame that includes interference information indicating an existence or an occurrence of a wireless communications interference and from the first wireless device, transmitting the frame to a second wireless device through an antenna.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a wireless communications system in accordance with an embodiment of the invention.

FIG. 2 depicts a multi-link communications system that is used for wireless communications in accordance with an embodiment of the invention.

FIG. 3 depicts a wireless device in accordance with an embodiment of the invention.

FIG. 4 depicts a wireless device with multiple wireless transceivers in accordance with an embodiment of the invention.

FIG. 5 depicts a frame with interference information in accordance with an embodiment of the invention.

FIG. 6 is a process flow diagram of a method for wireless communications in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

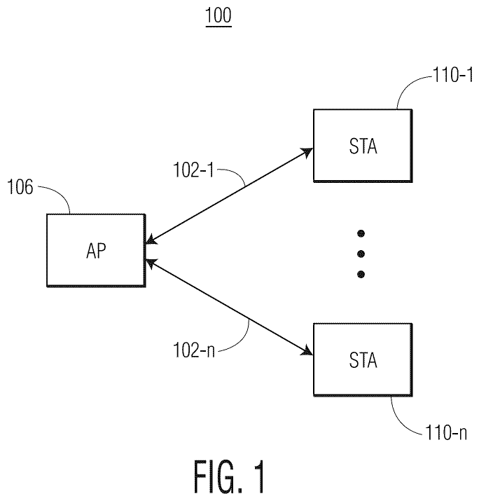

FIG. 1 depicts a wireless (e.g., WiFi) communications system 100 in accordance with an embodiment of the invention. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with one STA, multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications links. In some embodiments, the wireless communications system 100 described with reference to FIG. 1 involves multi-link communications and the AP and the STA communicate through multiple communications links. Furthermore, the techniques described herein may also be applicable to each link of a multi-link communications system.

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon acknowledgement establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communications device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements a common MAC data service interface and a lower layer MAC data service interface. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In some embodiments of a wireless communications system, a wireless device, e.g., an access point (AP) multi-link device (MLD) of a wireless local area network (WLAN) may transmit data to at least one associated station (STA) MLD (also referred to as a non-AP MLD). The AP MLD may be configured to operate with associated STA MLDs according to a communication protocol. For example, the communication protocol may be an Extremely High Throughput (EHT) communication protocol, or Institute of Electrical and Electronics Engineers (IEEE) 802.11be communication protocol. In some embodiments of the wireless communications system described herein, different associated STAs within range of an AP operating according to the EHT communication protocol are configured to operate according to at least one other communication protocol, which defines operation in a Basic Service Set (BSS) with the AP, but are generally affiliated with lower data throughput protocols. The lower data throughput communication protocols (e.g., High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

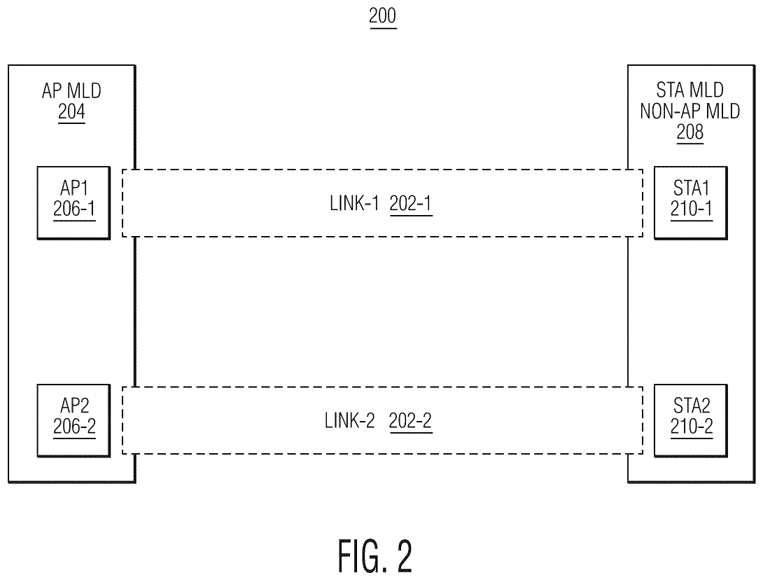

FIG. 2 depicts a multi-link communications system 200 that is used for wireless (e.g., WiFi) communications in accordance with an embodiment of the invention. In the embodiment depicted in FIG. 2, the multi-link communications system includes one AP multi-link device, which is implemented as AP MLD 204, and one non-AP STA multi-link device, which is implemented as STA MLD 208. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11be protocol. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-HE STAs) may associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two radios, implemented as APs 206-1 and 206-2. In such an embodiment, the APs may be AP1 206-1 and AP2 206-2. In some embodiments, a common part of the AP MLD 204 implements upper layer Media Access Control (MAC) functionalities (e.g., beaconing, association establishment, reordering of frames, etc.) and a link specific part of the AP MLD 204, i.e., the APs 206-1 and 206-2, implement lower layer MAC functionalities (e.g., backoff, frame transmission, frame reception, etc.). The APs 206-1 and 206-2 may be implemented in hardware (e.g., circuits), software, firmware, or a combination thereof. The APs 206-1 and 206-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with an IEEE 802.11be protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 106-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 206-2 may operate in a 160 MHz BSS operating channel at 5 GHz band. Although the AP MLD 204 is shown in FIG. 2 as including two APs, other embodiments of the AP MLD 204 may include more than two APs.

In the embodiment depicted in FIG. 2, the non-AP STA multi-link device, implemented as STA MLD 208, includes two radios which are implemented as non-AP STAs 210-1 and 210-2. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11be protocol, an IEEE 802.11ax protocol, or an IEEE 802.11ac protocol). In some embodiments, the STA MLD 208 implements a common MAC data service interface and the non-AP STAs 210-1 and 210-2 implement a lower layer MAC data service interface.

In some embodiments, the AP MLD 204 and/or the STA MLD 208 may identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP1 206-1 or AP2 206-2) that features multiple 20 MHz channels used to transmit frames (e.g., Physical Layer Convergence Protocol (PLCP) Protocol Data Units (PPDUs), Beacon frames, management frames, etc.) between a first wireless device (e.g., an AP, an AP MLD, an STA, or an STA MLD) and a second wireless device (e.g., an AP, an AP MLD, an STA, or an STA MLD). In some embodiments, a 20 MHz channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via the communications links 202-1 and 202-2, in other embodiments, the AP MLD 204 may communicate (e.g., wirelessly communicate) with the STA MLD 208 via more than two communication links or less than two communication links.

In some embodiments, a first MLD, e.g., an AP MLD or non-AP MLD (STA MLD), may transmit management frames in a multi-link operation with a second MLD, e.g., STA MLD or AP MLD, to coordinate the multi-link operation between the first MLD and the second MLD. As an example, a management frame may be a channel switch announcement frame, a (Re) Association Request frame, a (Re) Association Response frame, a Beacon frame, a Disassociation frame, an Authentication frame, and/or a Block Acknowledgement (Ack) (BA) Action frame, etc. In some embodiments, one or more management frames may be transmitted via a cross-link transmission (e.g., according to an IEEE 802.11be communication protocol). As an example, a cross-link management frame transmission may involve a management frame being transmitted and/or received on one link (e.g., link 1 202-1) while carrying information of another link (e.g., link 2 202-2). In some embodiments, a management frame is transmitted on any link (e.g., at least one of two links or at least one of multiple links) between a first MLD (e.g., AP MLD 204) and a second MLD (e.g., STA MLD 208). As an example, a management frame may be transmitted between a first MLD and a second MLD on any link (e.g., at least one of two links or at least one of multiple links) associated with the first MLD and the second MLD.

A wireless communications interference, such as In-device coexisting radio(s) (e.g., a Bluetooth transmitter), may interfere with a WLAN (e.g., Wi-Fi) transmitter because the WLAN (e.g., Wi-Fi) transmitter might know for periodic activity or might not know for aperiodic activity beforehand when the interference may occur. A WLAN (e.g., Wi-Fi) device can announce that the device has one or more coexisting radios/transmitters when performing the association or after the in-device coexisting radio(s) is turned on or turned off. This information can help its connected WLAN (e.g., Wi-Fi) device to optimize rate adaptation in transmission. Techniques to indicate past occurrence of a dynamic or unpredictable coexisting interference in a timely manner may include, that a WLAN (e.g., Wi-Fi) victim can indicate one or multiple interfered PPDUs through an immediate BA or a BA following a BAR, or the other control frames, that a WLAN (e.g., Wi-Fi) victim can indicate one or multiple interfered PPDUs though a Quality of service (QOS) Null frame, and that a WLAN (e.g., Wi-Fi) victim can indicate a past time period in which interference occurred. Knowing that a WLAN (e.g., Wi-Fi) receiver's error packets are resulted from a coexisting interference instead of a bad channel condition can improve wireless transmission throughput, for example, by preventing a WLAN (e.g., Wi-Fi) transmitter from dropping data packets, resulting in a lower data rate.

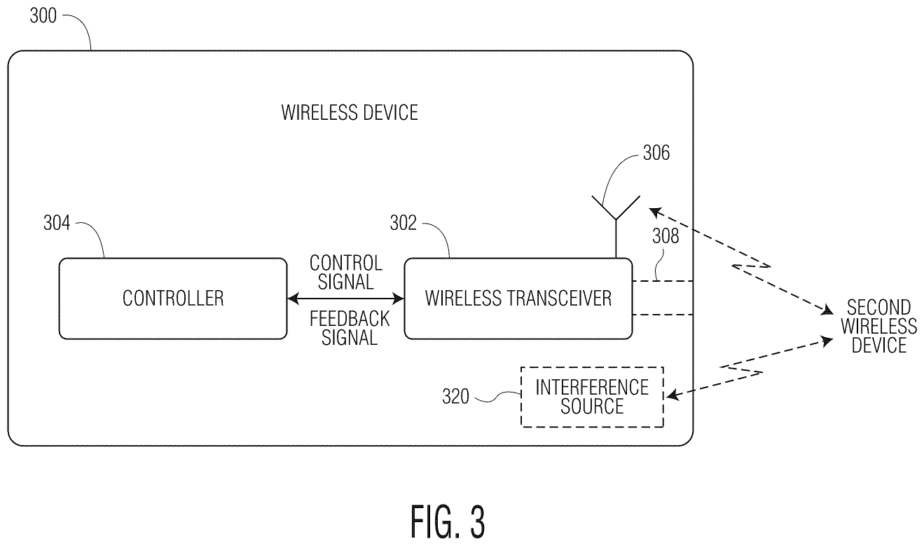

FIG. 3 depicts a wireless device 300 in accordance with an embodiment of the invention. The wireless device 300 can be used in the wireless communications system 100 depicted in FIG. 1 and/or the multi-link communications system 200 depicted in FIG. 2 for each link independently. For example, the wireless device 300 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 3, the wireless device 300 includes a wireless transceiver 302, a controller 304 operably connected to the wireless transceiver, and at least one antenna 306 operably connected to the wireless transceiver. In some embodiments, the wireless device 300 may include at least one optional network port 308 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 300 includes multiple transceivers. The controller may be configured to control the wireless transceiver (e.g., by generating a control signal) to process packets received through the antenna and/or the network port and/or to generate outgoing packets to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 302 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

In accordance with an embodiment of the invention, the controller 304 is configured to generate a frame (e.g., a Physical Layer Convergence Protocol (PLCP) Protocol Data Unit (PPDUs), a beacon frame, or a management frame, etc.) that includes interference information indicating an existence or an occurrence of a wireless communications interference and the wireless transceiver 302 configured to transmit the frame through the antenna 306. In some embodiments, the interference information indicates that an interference source 320 is located within the wireless device. For example, the interference source 320 may be an in-device coexisting transmitter/radio (e.g., a Bluetooth transmitter/radio) and/or other known interference source. In some embodiments, the wireless device 300 may further include a second wireless transceiver, and the interference information may indicate that the interference source includes the second wireless transceiver. In some embodiments, the wireless transceiver 302 is compatible with an Institute of Electrical and Electronics Engineers (IEEE) 802.11 protocol, while the second wireless transceiver is not compatible with the IEEE 802.11 protocol. For example, the second wireless transceiver may be compatible with a short range wireless communications protocol. In some embodiments, the interference information includes interference activation indication information, periodic indication information, and interference bandwidth bitmap information, for example, announced by a management frame. In some embodiments, the interference information includes interference activation indication information, periodic indication information, interference bandwidth bitmap information that is within a Basic Service Set (BSS) operating bandwidth (BW), and a restriction of transmitter/receiver (Tx/Rx) parameters. In some embodiments, the interference information further includes periodic in-device radio service period (SP) information, for example, announced by a management frame. In some embodiments, the interference information further includes the transmitter (Tx) parameter restriction and receiver (Rx) parameter restriction for periodic interference during the periodic in-device radio service period (SP) or for aperiodic interference announced by the management frame. In some embodiments, the interference information periodic in-device radio service period (SP) includes the start time, duration of the SP, the interval of the adjacent SPs. In some embodiments, the management frame for the interference announcement includes a beacon frame, a Probe Response frame, a (Re) Association Request/Response frame, and/or a newly defined Action frame. For example, the interference information indicates the existence of the wireless communications interference with a second wireless device, and the wireless transceiver is further configured to transmit the beacon frame, the Probe Response frame, the (Re) Association Request/Response frame, or the a newly defined Action frame to announce interference information. In some embodiments, the temporal interference information indicates that erroneous or missing Media Access Control (MAC) protocol data units (MPDUs) in one or more physical layer protocol data units (PPDUs) caused by the wireless communications interference. In these embodiments, the frame may include a block acknowledgment (BA) frame for indicating temporal interference information. In some embodiments, the temporal interference information indicates that unacknowledged MPDUs caused by the wireless communications interference. In these embodiments, the frame includes a Quality of service (QOS) Null frame with an HE Control field or an action frame with an HE Control field where the HE Control field carries the temporal interference information. In some embodiments, the interference information indicates a past period in which the wireless communications interference occurred. In some embodiments, the interference information indicates the existence of the wireless communications interference with a second wireless device, second interference information transmitted by the second wireless device in a responding frame indicates an available time duration that is smaller than a remaining transmit opportunity (TXOP) duration, and the wireless device as a TXOP holder finishes a frame exchange with the second wireless device within the second wireless device's available time duration. In some embodiments, the second interference information is carried in a duration field, e.g., a duration field of the responding frame's Media Access Control (MAC) header. In some embodiments, the wireless device 300 includes a wireless access point (AP) or a non-AP wireless station (STA) device. In some embodiments, the temporal interference information indicates the available time (the available time period from now) and unavailable time (the start time of future unavailable period, the duration of the future unavailable period). In some embodiments, the wireless device 300 is a component of a multi-link device (MLD), and the interference information of the wireless device is reported to a peer wireless device of the MLD that is connected to the wireless device via a first link through a second link.

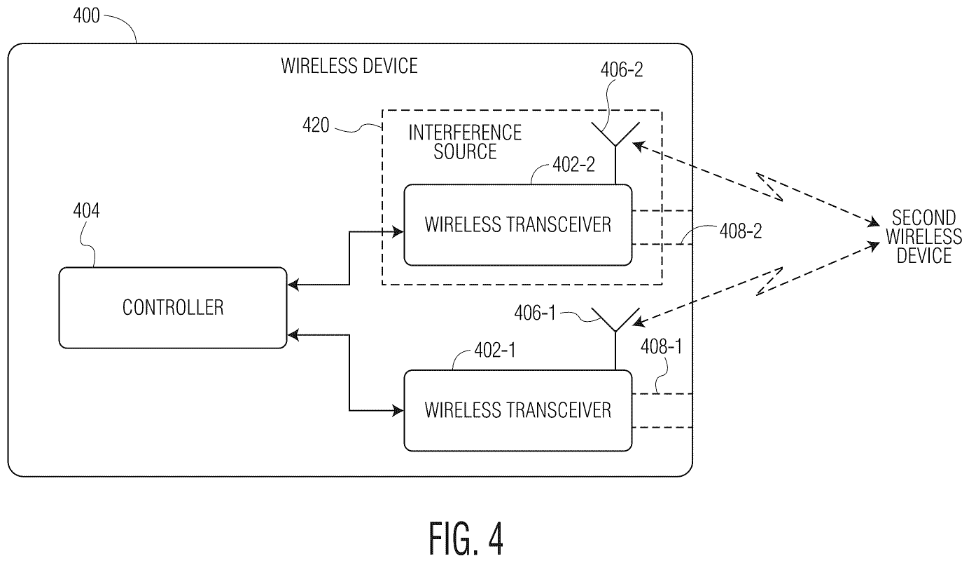

FIG. 4 depicts a wireless device 400 with multiple wireless transceivers 402-1, 402-2 in accordance with an embodiment of the invention. The wireless device 400 depicted in FIG. 4 may be an embodiment of the wireless device 300 depicted in FIG. 3. However, the wireless device 300 depicted in FIG. 3 is not limited to the embodiment depicted in FIG. 4. The wireless device 400 can be used in the wireless communications system 100 depicted in FIG. 1 and/or the multi-link communications system 200 depicted in FIG. 2. For example, the wireless device 400 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 4, the wireless device 400 includes the first wireless transceiver 402-1, the second wireless transceiver 402-2, a controller 404 operably connected to the wireless transceiver, a first antenna 406-1 operably connected to the first wireless transceiver 402-1, and a second antenna 406-2 operably connected to the second wireless transceiver 402-2. In some embodiments, the wireless device 400 may include one or more optional network ports 408-1, 408-2 operably connected to the wireless transceivers 402-1, 402-2. In some embodiments, at least one of the wireless transceivers 402-1, 402-2 includes a physical layer (PHY) device. The wireless transceivers 402-1, 402-2 may be any suitable type of wireless transceiver. For example, one of the wireless transceivers 402-1, 402-2 may be a WLAN transceiver (e.g., a transceiver compatible with an IEEE 802.11 protocol) while another one of the wireless transceivers 402-1, 402-2 may be a short-range transceiver (e.g., a transceiver compatible with a Bluetooth communications protocol). The controller may be configured to control the wireless transceivers 402-1, 402-2 (e.g., by generating one or more control signals) to process packets received through the antennas 406-1, 406-2 and/or the network ports 408-1, 408-2 and/or to generate outgoing packets to be transmitted through the antennas 406-1, 406-2 and/or the network ports 408-1, 408-2. In some embodiments, the wireless transceivers 402-1, 402-2 transmits one or more feedback signals to the controller 404. In some embodiments, the controller is implemented within a processor, such as a microcontroller, a host processor, a host, a DSP, or a CPU. In some embodiments, at least one of the wireless transceivers 402-1, 402-2 is implemented in hardware (e.g., circuits), software, firmware, or a combination thereof. The antenna may be any suitable type of antenna. For example, at least one of the antennas 406-1, 406-2 may be an induction type antenna such as a loop antenna or any other suitable type of induction type antenna. However, the antennas 406-1, 406-2 are not limited to induction type antennas. The network ports 408-1, 408-2 may be any suitable type of ports. For example, at least one of the network ports 408-1, 408-2 is an LAN port (e.g., an Ethernet port). Although the depicted wireless device 400 is shown in FIG. 4 with certain components and described with certain functionality herein, other embodiments of the wireless device 400 may include fewer or more components to implement the same, less, or more functionality. For example, although the wireless device 400 is shown in FIG. 4 as being connected in a certain topology, the network topology of the wireless device 400 is not limited to the topology shown in FIG. 4. In another example, in some embodiments, the wireless device includes multiple controllers with multiple wireless transceivers, a single antenna, more than two wireless transceivers, more than one antennas, and/or more than two network ports.

In accordance with an embodiment of the invention, the controller 404 is configured to generate a frame (e.g., a Physical Layer Convergence Protocol (PLCP) Protocol Data Unit (PPDUs), a beacon frame, or a management frame, etc.) that includes interference information indicating an existence or an occurrence of a wireless communications interference and the wireless transceiver 402-1 is configured to transmit the frame through the antenna 406-1. In some embodiments, the wireless device 400 is a wireless access point (AP) or a non-AP wireless station (STA) device. In some embodiments, the wireless device 400 is a component of a multi-link device (MLD).

In some embodiments, the interference information indicates that an interference source 420 is located within the wireless device 400. For example, the interference source 420 may be an in-device coexisting transceiver/radio (e.g., a Bluetooth transceiver/radio) and/or other known interference source. In some embodiments, the wireless device further includes the second wireless transceiver 402-2, and the interference information indicates that the interference source 420 includes the second wireless transceiver 402-2 and/or the second antenna 406-2. In some embodiments, the first wireless transceiver 402-1 is compatible with an Institute of Electrical and Electronics Engineers (IEEE) 802.11 protocol, and the second wireless transceiver 402-2 is not compatible with the IEEE 802.11 protocol. In some embodiments, the second wireless transceiver 402-2 is compatible with a short range wireless communications protocol. In some embodiments, the interference information includes interference activation indication information, periodic indication information, and interference bandwidth bitmap information. In some embodiments, the interference information further includes periodic in-device radio service period (SP) information. In some embodiments, the frame includes a beacon frame.

In some embodiments, the interference information indicates the existence of the wireless communications interference with a second wireless device, and the wireless transceiver 402-1 is further configured to transmit the beacon frame to announce the interference information. In some embodiments, the interference information indicates that erroneous or missing Media Access Control (MAC) protocol data units (MPDUs) in one or more physical layer protocol data units (PPDUs) caused by the wireless communications interference. In these embodiments, the frame may include a block acknowledgment (BA) frame. In some embodiments, the interference information indicates that unacknowledged MPDUs caused by the wireless communications interference. In these embodiments, the frame may include a Quality of service (QOS) Null frame with an HE Control field or an action frame with an HE Control field. In some embodiments, the interference information indicates a past period in which the wireless communications interference occurred.

An announcement of a known interference source may be implemented. In some embodiments, an AP or a non-AP STA (e.g., the wireless device 300 depicted in FIG. 3 and/or the wireless device 400 depicted in FIG. 4) announces the existence of in-device coexisting transmitters/radios or any other known interference during connection reaction in a Beacon frame, a Probe Request frame, a (Re) Association Request/Response frame, or other Management frame, e.g., a new Action frame. For example, the following are related fields to describe in-device coexisting transmitters/radios in a frame or in a new defined element in a frame:
an Active Indication field, which can be Active or Inactive;
a Periodic Indication field, which can be Periodic or Nonperiodic;
an Interfere bandwidth (BW) Bitmap field, where the bit(s) being 1 or a specific value to indicate the location of the BW being interfered by the in-device coexisting transmitters/radios. For example, each bit in the bitmap indicates a 20 MHz channel where the least significant bit (LSB) indicates the 20 MHz channel with the lowest frequency covered by the BSS operating channel; and
a Periodic In-device Radio service period (SP) field (optional one or multiple such fields may be carried if the Periodic Indication field indicates the Periodic value) includes Start Time, SP Duration, Interval, the Tx/RX parameters of the PPDU, e.g., smaller Modulation Coding Scheme (MCS), and the number of spatial streams (Nss) than its capabilities within the service periods (SPs).

In some embodiments, when a STA announces its interference 20 MHz channels in an Interfere bandwidth (BW) Bitmap field, the Interfere bandwidth (BW) Bitmap field may cover the BSS operating BW instead of the STA's operating BW. For example, this is required when the STA can dynamically switch to the secondary 20 MHz channels that are not covered by the STA's operating BW. Such dynamic switch is per transmit opportunity (TXOP) basis when the primary channel is busy because of an Overlapping BSS (OBSS) TXOP/PPDU or when the associated AP requests STA's channel switch through a Trigger frame.

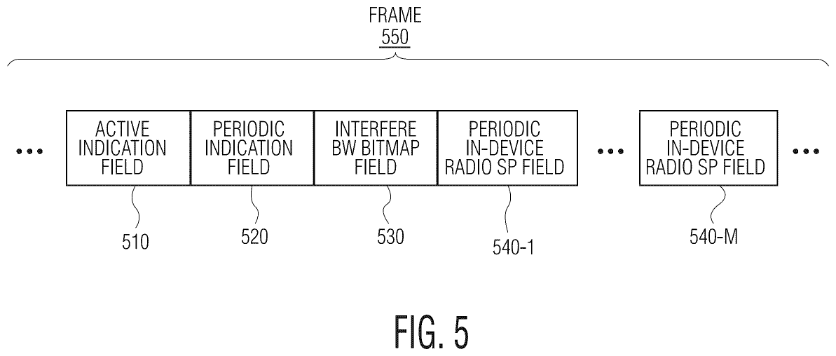

FIG. 5 depicts a frame 550 with interference information in accordance with an embodiment of the invention, which may be generated by an AP or a non-AP STA (e.g., the wireless device 300 depicted in FIG. 3 and/or the wireless device 400 depicted in FIG. 4). In the embodiment depicted in FIG. 5, the frame 550 (e.g., a PPDU) includes an Active Indication field 510, a Periodic Indication field 520, an Interfere BW Bitmap field 530, and one or more optional Periodic In-device Radio SP field 540-1, . . . , 540-M, where M is a positive integer, which may be included in a new defined element in the frame. The Active Indication field 510, the Periodic Indication field 520, the Interfere BW Bitmap field 530, and the optional Periodic In-device Radio SP fields 540-1, . . . , 540-M may be included in the header and/or the payload of the frame 550. The value of the Active Indication field 510 may be set to Active or Inactive. The value of the Periodic Indication field 520 may be set to Periodic or Nonperiodic. The Interfere BW Bitmap field 530 includes data bit(s), which can be set to 1 or a specific value to indicate the location of the BW being interfered by the in-device coexisting transmitters/radios. For example, each bit in the bitmap indicates a 20 MHz channel where the least significant bit (LSB) indicates the 20 MHz channel with the lowest frequency covered by the BSS operating channel. In some embodiments, at least one of the Periodic In-device Radio SP fields 540-1, . . . , 540-M includes Start Time, SP Duration, Interval, the PPDU with smaller Modulation Coding Scheme (MCS), and the number of spatial streams (Nss) than its capabilities within the service periods (SPs). In some embodiments, the Periodic In-device Radio SP fields 540-1, . . . , 540-M are carried if the Periodic Indication field indicates or has a Periodic value.

Announcement of past occurrence of interference may be implemented. In some embodiments, an immediate BA (e.g., a Multi-STA BA) is used by an AP or a non-AP STA (e.g., the wireless device 300 depicted in FIG. 3 and/or the wireless device 400 depicted in FIG. 4) to indicate erroneous or missing MPDUs caused by coexisting or known interference whenever an immediate BA can be sent. In some embodiments, one bit indication for erroneous MPDUs in the PPDU preceding the immediate BA is added. In some embodiments, a second bit is added to indicate erroneous or missing MPDUs in PPDUs before the preceding PPDU.

In some embodiments, a QoS Null or newly defined action frame with a modified Bandwidth Query Report (BQR) HE Control field (A-Control field) or a new defined HE Control field is used by an AP or a non-AP STA (e.g., the wireless device 300 depicted in FIG. 3 and/or the wireless device 400 depicted in FIG. 4) to indicate unacknowledged MPDUs caused by coexisting or known interference whenever an immediate BA or a BA following a BAR cannot be sent. In some embodiments, one reserved bit in a BQR A-Control field is used as an indication of an unacknowledged PPDU preceding the transmission. In some embodiments, a second reserved bit in a BQR A-Control field is used as an indication of multiple unacknowledged PPDUs preceding the transmission. For applicable scenarios, a detected and received PPDU but immediate BA cannot be sent due to resource being occupied by a coexisting radio. Undetected PPDU(s)+ detected PPDU and an BA cannot be sent following the detected PPDU.

In some embodiments, a HE Control field in QoS Null or a Per AID (Association ID) Traffic Identifier (TID) Info field with specific AID11 value in multi-STA BA (or any frame from an AP STA to multiple non-AP STAs) is used by an AP or a non-AP STA (e.g., the wireless device 300 depicted in FIG. 3 and/or the wireless device 400 depicted in FIG. 4) to indicate a past period in which interference occurred, e.g., the start time of the interference in timing synchronization function (TSF) time (either partial TSF time or full TSF time) and/or the duration of the interference. For applicable scenarios, a STA can send a notification after an occurred interference without waiting to receive any PPDU to prevent rate drop in a possible shortest time.

Impact mitigation of in-device coexisting interference under MLD may be implemented. In some embodiments, the impact mitigation of in-device coexisting Interference is a link level feature when a non-AP STA or an AP (e.g., the wireless device 300 depicted in FIG. 3 and/or the wireless device 400 depicted in FIG. 4) is affiliated with non-AP/AP MLD. In some embodiments, the related management frame for one link can be transmitted by an AP or a non-AP STA (e.g., the wireless device 300 depicted in FIG. 3 and/or the wireless device 400 depicted in FIG. 4) in another link. In some embodiments, the Multi-Link Operation (MLO) Link Information element in the frame indicates the link where the management frame is applied. In some embodiments, any information of the coexisting radios other than Wi-Fi in one link can be reported in another link through one or more Action, HE Control data field(s) in a Data/Management frame.

Duration-based interference avoiding may be implemented. In some embodiments, the Duration field in the MAC header of a frame from a transmit opportunity (TXOP) responder can be used by an AP or a non-AP STA (e.g., the wireless device 300 depicted in FIG. 3 and/or the wireless device 400 depicted in FIG. 4) to indicate the end time of the expected frames exchanges with the TXOP responder, i.e., the TXOP responder's available time. In some embodiments, the TXOP responder can be the STA or the AP. In some embodiments, the frame can be a Data frame, a Management frame or a responding Control frame. In some embodiments, when multiple TXOP responders transmit the Clear To Send (CTS) at the same channel, a TXOP responder cannot use the Duration field of the CTS to indicate the end time of the expected frames exchanges with the TXOP responder. In some embodiments, a trigger-based (TB) PPDU is used to carry the responding frames from multiple STAs and in each 20 MHz channel, no more than one responding STAs are allocated to send the responding frames. In some embodiments, a TB PPDU is used to carry the responding frames from multiple STAs and the duration information in PHY header is set to UNSPECIFIED when more than one responders use the same 20 MHz channel to send the responding frames.

In-Device radio announcements may be implemented. In some embodiments, an AP or a non-AP STA (e.g., the wireless device 300 depicted in FIG. 3 and/or the wireless device 400 depicted in FIG. 4) announces/negotiates whether it has active in-device non-WiFi radio with aperiodic SPs and the Tx/Rx parameters being used in the aperiodic SPs. In some embodiments, the BW is interfered by the active in-device non-WiFi radio in unit of 20 MHz. The 20 MHz channel bitmap can be used for such report. In some embodiments, the MCS and/or the Nss are smaller than its capabilities within aperiodic SPs. In some embodiments, an AP considers its associated STA's active in-device non-WiFi radio information when conducting multi-user (MU) transmission, link adaptation, rate/MCS selection. In some embodiments, a STA considers its associated AP's active in-device non-WiFi radio information when conducting link adaptation, rate/MCS selection.

In some embodiments, a method to mitigate the impact of coexisting radio interference or any known interference on a first device as a result of erroneous and/or missing receive packets transmitted from a second device is implemented, the first device is either a client STA with a wireless transceiver/radio supporting 802.11 and one or more other wireless transceivers/radios support other wireless communication technologies or an AP with a wireless transceiver/radio supporting 802.11 and one or more other wireless transceivers/radios support other wireless communication technologies, or a STA with a wireless transceiver/radio supporting 802.11 with other known interference. In some embodiments, the method further includes indicating, by the first device, the existence of in-device coexisting wireless transceivers/radios or any other known interference during connection creation or when status changes happen in coexisting wireless transceivers/radios or interference. In some embodiments, the announced in-device coexisting wireless transceiver/radio information includes whether the existing in-device coexisting wireless transceivers/radios create periodic interference, the influenced BW in unit of 20 MHz, the start time, duration, and/or interval of the periodic interference durations if the periodic interference is announced. In some embodiments, the method further includes indicating, by the first device, erroneous or missing MPDUs in one or more PPDUs caused by coexisting or other known interference. In some embodiments, the indication is carried in block acknowledgment. In some embodiments, the method further includes indicating, by the first device, unacknowledged MPDUs caused by coexisting or other known interference. In some embodiments, the indication is carried in QoS Null or newly defined action frame containing modified BQR A-Control field or a newly defined HE Control field. In some embodiments, the method further includes indicating, by the first device, a past period in which interference occurred. In some embodiments, the past period includes the start time in (partial) TSF time and/or the duration of the period.

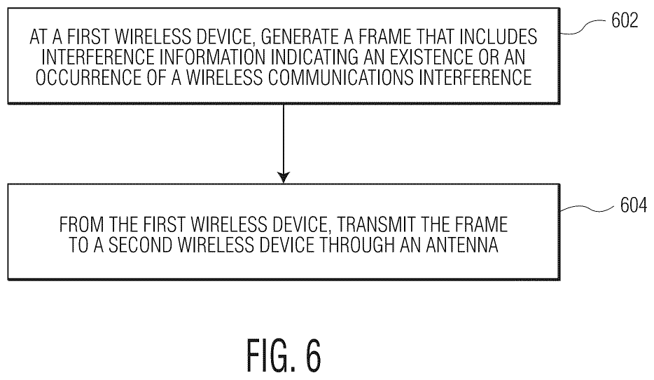

FIG. 6 is a process flow diagram of a method for wireless communications in accordance with an embodiment of the invention. At block 602, at a first wireless device, a frame that includes interference information indicating an existence or an occurrence of a wireless communications interference is generated. At block 604, from the first wireless device, the frame is transmitted to a second wireless device through an antenna. In some embodiments, the interference information indicates that an interference source is located within the first wireless device. In some embodiments, the first wireless device includes a first wireless transceiver from which the frame is transmitted to the second wireless device through the antenna and a second wireless transceiver, and the interference information indicates that the interference source includes the second wireless transceiver. In some embodiments, the first wireless transceiver is compatible with an Institute of Electrical and Electronics Engineers (IEEE) 802.11 protocol, while the second wireless transceiver is not compatible with the IEEE 802.11 protocol. In some embodiments, the second wireless transceiver is compatible with a short range wireless communications protocol. In some embodiments, the interference information includes interference activation indication information, periodic indication information, and interference bandwidth bitmap information. In some embodiments, the interference information includes interference activation indication information, periodic indication information, interference bandwidth bitmap information that is within a Basic Service Set (BSS) operating bandwidth (BW), and a restriction of transmitter/receiver (Tx/Rx) parameters. In some embodiments, the interference information further includes periodic in-device radio service period (SP) information. In some embodiments, the frame includes a beacon frame, a probe response, or an association request/response frame. In some embodiments, the interference information indicates the existence of the wireless communications interference with the second wireless device, and the beacon frame, the probe response, or the association request/response frame is transmitted to announce the interference information and/or establish a wireless connection with the second wireless device. In some embodiments, the interference information indicates that erroneous or missing MPDUs in one or more PPDUs caused by the wireless communications interference. In these embodiments, the frame may include a block acknowledgment (BA) frame. In some embodiments, the interference information indicates that unacknowledged MPDUs caused by the wireless communications interference. In these embodiments, the frame may include a Quality of service (QOS) Null frame or an action frame. In some embodiments, the interference information indicates a past period in which the wireless communications interference occurred. In some embodiments, the interference information indicates the existence of the wireless communications interference with a second wireless device, second interference information transmitted by the second wireless device in a responding frame indicates an available time duration that is smaller than a remaining transmit opportunity (TXOP) duration, and the wireless device as a TXOP holder finishes a frame exchange with the second wireless device within the second wireless device's available time duration. In some embodiments, the second interference information is carried in a duration field of the responding frame's MAC header or the responding frame's frame body. In some embodiments, the first wireless device or the second wireless device includes a wireless access point (AP) or a non-AP wireless station (STA) device. In some embodiments, the first wireless device or the second wireless device is a component of a multi-link device (MLD), and the interference information of the wireless device is reported to a peer wireless device of the MLD that is connected to the wireless device via a first link through a second link. The first wireless device and/or the second wireless device may be the same as or similar to an embodiment of the AP 106 depicted in FIG. 1, the STA 110-1, . . . , 110-n depicted in FIG. 1, the APs 206-1, 206-2 depicted in FIG. 2, the STAs 210-1, 210-2 depicted in FIG. 2, the wireless device 300 depicted in FIG. 3, and/or the wireless device 400 depicted in FIG. 4.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A wireless device comprising:
a controller configured to generate a frame that comprises interference information indicating an existence or an occurrence of a wireless communications interference; and
a wireless transceiver configured to transmit the frame through an antenna.

2. The wireless device of claim 1, wherein the interference information indicates that an interference source is located within the wireless device.

3. The wireless device of claim 2, wherein the wireless device further comprises a second wireless transceiver, and wherein the interference information indicates that the interference source comprises the second wireless transceiver.

4. The wireless device of claim 3, wherein the wireless transceiver is compatible with an Institute of Electrical and Electronics Engineers (IEEE) 802.11 protocol, and wherein the second wireless transceiver is not compatible with the IEEE 802.11 protocol.

5. The wireless device of claim 4, wherein the second wireless transceiver is compatible with a short range wireless communications protocol.

6. The wireless device of claim 2, wherein the interference information comprises interference activation indication information, periodic indication information, interference bandwidth bitmap information that is within a Basic Service Set (BSS) operating bandwidth (BW), and a restriction of transmitter/receiver (Tx/Rx) parameters.

7. The wireless device of claim 6, wherein the interference information further comprises periodic in-device radio service period (SP) information.

8. The wireless device of claim 2, wherein the frame comprises a beacon frame, a probe response, or an association request/response frame.

9. The wireless device of claim 8, wherein the interference information indicates the existence of the wireless communications interference with a second wireless device, and wherein the wireless transceiver is further configured to transmit the beacon frame, the probe response, or the association request/response frame to announce the interference information.

10. The wireless device of claim 1, wherein the interference information indicates that a plurality of erroneous or missing Media Access Control (MAC) protocol data units (MPDUs) in one or more physical layer protocol data units (PPDUs) caused by the wireless communications interference.

11. The wireless device of claim 10, wherein the frame comprises a block acknowledgment (BA) frame.

12. The wireless device of claim 1, wherein the interference information indicates that a plurality of unacknowledged Media Access Control (MAC) protocol data units (MPDUs) caused by the wireless communications interference.

13. The wireless device of claim 10, wherein the frame comprises a Quality of service (QOS) Null frame or an action frame.

14. The wireless device of claim 1, wherein the interference information indicates a past period in which the wireless communications interference occurred.

15. The wireless device of claim 1, wherein the interference information indicates the existence of the wireless communications interference with a second wireless device, wherein second interference information transmitted by the second wireless device in a responding frame indicates an available time duration that is smaller than a remaining transmit opportunity (TXOP) duration, and wherein the wireless device as a TXOP holder finishes a frame exchange with the second wireless device within the second wireless device's available time duration.

16. The wireless device of claim 15, wherein the second interference information is carried in a duration field of the responding frame's Media Access Control (MAC) header.

17. The wireless device of claim 1, wherein the wireless device comprises a wireless access point (AP) or a non-AP wireless station (STA) device.

18. The wireless device of claim 1, wherein the wireless device is a component of a multi-link device (MLD), and wherein the interference information of the wireless device is reported to a peer wireless device of the MLD that is connected to the wireless device via a first link through a second link.

19. A wireless device comprising:
a controller configured to generate a beacon frame that comprises interference information indicating an existence of a wireless communications interference with a second wireless device; and
a wireless transceiver configured to transmit the beacon frame to the second wireless device through an antenna.

20. A method for wireless communications, the method comprising:
at a first wireless device, generating a frame that comprises interference information indicating an existence or an occurrence of a wireless communications interference; and
from the first wireless device, transmitting the frame to a second wireless device through an antenna.
